(19) United States
(12) Patent Application Publication
(10) Pub. No.: US 2011/0238419 A1
(43) Pub. Date: Sep. 29, 2011

(54) BINAURAL METHOD AND BINAURAL CONFIGURATION FOR VOICE CONTROL OF HEARING DEVICES

(75) Inventor: Roland Barthel, Erlangen (DE)

(73) Assignee: SIEMENS MEDICAL INSTRUMENTS PTE. LTD., Singapore (SG)

(21) Appl. No.: 13/070,646

(22) Filed: Mar. 24, 2011

(30) Foreign Application Priority Data
Mar. 24, 2010 (DE) 10 2010 012 622.5

(51) Int. Cl. G10L 15/00

(52) U.S. Cl. 704/251; 704/E15.001

(57) ABSTRACT

A binaural configuration and an associated method have/utilize first and second hearing devices for the voice control of the hearing devices by voice commands. The configuration contains a first voice recognition module in the first hearing device and a second voice recognition module in the second hearing device. The second voice recognition module uses information data from the first voice recognition module for recognition of the voice commands. It is here advantageous that the rate of erroneously recognized voice commands (“false alarms”) is reduced.

### CROSS-REFERENCE TO RELATED APPLICATION

This application claims the priority, under 35 U.S.C. §119, of German application DE 10 2010 012 622.5, filed Mar. 24, 2010; the prior application is herewith incorporated by reference in its entirety.

### BACKGROUND OF THE INVENTION

### Field of the Invention

The invention relates to a binaural method and a binaural configuration for the voice control of hearing devices with voice commands using a first and a second hearing device. The term hearing device should here be taken to mean both tinnitus-markers and anti-stammer aids as well as hearing aids for the hearing-impaired.

In principle, hearing devices have as their essential components an input converter, an amplifier and an output converter. The input converter is as a rule a sound receiver, for example a microphone, and/or an electromagnetic receiver, for example an induction coil. The output converter is generally realized as an electro-acoustic converter, for example a miniature speaker, or as an electromechanical converter, for example a bone conduction earphone. The amplifier is generally integrated into a signal processing unit. This structural principle is represented in FIG. 1 using the example of a behind-the-ear hearing device 1. Generally, two microphones 3 for receiving the ambient sound are built into a hearing device housing 2 for wearing behind the ear. Above the microphones 3, microphone openings 7 are embodied in the hearing device housing 2. The sound can reach the microphones 3 in the interior of the hearing device housing 2 through the microphone openings 7. A signal processing unit 4, which is likewise integrated into the hearing device housing 2, processes the microphone signals and amplifies them. The output signal of the signal processing unit 4 is transferred to a speaker or earpiece 5, which emits an acoustic signal. If applicable, the sound is transferred to the eardrum of the hearing device wearer via a sound tube (not shown), which is fixed in the auditory canal with an otoplastic. The power supply of the hearing devices 1 and in particular that of the signal processing unit 4 is provided by battery 6, likewise integrated into the hearing device housing 2.

Binaural provision for the hearing impaired indicates provision with a right and a left hearing device. The hearing losses of both ears can thereby be individually harmonized. So that the advantages of a binaural provision are optimally used, these communicate with each other wirelessly and exchange data. U.S. patent publication No. 2004/0037442 A1 describes a binaural hearing device configuration of this kind.

Investigations conducted by the applicant support the view that voice control of hearing devices significantly improves wearer convenience. The frequently irksome operation by a remote control or small adjustment buttons on the hearing device can thus frequently be avoided. Published, non-prosecuted German patent application DE 10 2007 056 221 A1 specifies a solution, such as can also be realized for the voice recognition required for voice control with the available computing power of a hearing device. Nevertheless, the recognition rate in everyday use leaves something to be desired. Too many “false alarms” occur, that is the hearing device recognizes a valid command, although no such command has been uttered by the hearing device wearer. The cause of this is that the known voice recognition algorithms are not yet optimally adjusted to application in hearing devices, or cannot be adjusted thereto with a reasonable level of effort.

### SUMMARY OF THE INVENTION

It is accordingly an object of the invention to provide a binaural method and a binaural configuration for voice control of hearing devices which overcome the above-mentioned disadvantages of the prior art methods and devices of this general type, which prevents “false alarms” and improve the voice control of hearing devices.

With the foregoing and other objects in view there is provided, in accordance with the invention a method for voice control of hearing devices using voice commands. The hearing devices include a first hearing device and a second hearing device in binaural configuration. The method includes the steps of transferring information data from a second voice recognition method of the second hearing device method to a first voice recognition method of a first hearing device; and using, in a first voice recognition method of the first hearing device, the information data from the second voice recognition method of the second hearing device for recognition of the voice commands.

The invention claims a method for the voice control of hearing devices with voice commands using a first hearing device and a second hearing device in a binaural configuration. Here a first voice recognition method of the first hearing device uses information data from a second voice recognition method of the second hearing device for the recognition of the voice commands. It is advantageous here that the rate of erroneously recognized voice commands (“false alarms”) is reduced while at the same time maintaining the ‘hit’ rate.

In a development of the method the information data can contain a second voice command recognized by the second voice recognition method. Voice control is thereby less prone to error and more robust.

In a further embodiment of the method a voice command is only then used for voice control if the second voice command corresponds with a first voice command recognized by the first voice recognition method.

The information data can further contain acoustic parameters, results of a Voice Activity Detection and/or levels of probability of recognized voice commands.

In a further embodiment the second voice recognition method can be the same as the first voice recognition method.

In addition the information data can be transmitted wirelessly from the first hearing device to the second hearing device.

The invention also claims a binaural configuration with a first and a second hearing device for the voice control of hearing devices by voice commands. The configuration contains a first voice recognition module in the first hearing device and a second voice recognition module in the second hearing device, which uses information data from the first voice recognition module for the recognition of the voice commands.

In a development of the configuration the information data can contain a first voice command recognized by the first voice recognition module.

In a further embodiment of the configuration a voice command is only then used for voice control if the first voice command corresponds with a second voice command recognized by the second voice recognition module.

The information data of the configuration can further contain acoustic parameters, results of a Voice Activity Detection and/or levels of probability of recognized voice commands.

In a further embodiment the configuration can contain a first voice recognition algorithm in the first voice recognition module and a second voice recognition algorithm in the second voice recognition module.

In a development of the configuration, the first voice recognition algorithm can be the same as the second voice recognition algorithm.

The configuration can additionally contain a first radio module in the first hearing device and a second radio module in the second hearing device, where the first radio module transfers the information data to the second radio module.

Other features which are considered as characteristic for the invention are set forth in the appended claims.

Although the invention is illustrated and described herein as embodied in a binaural method and a binaural configuration for voice control of hearing devices, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, illustration of a behind-the-ear hearing device according to the prior art;

FIG. 2 is a flow diagram illustrating a binaural voice control according to the invention; and

FIG. 3 is a block diagram showing a configuration with two hearing devices for binaural voice recognition according to the invention.

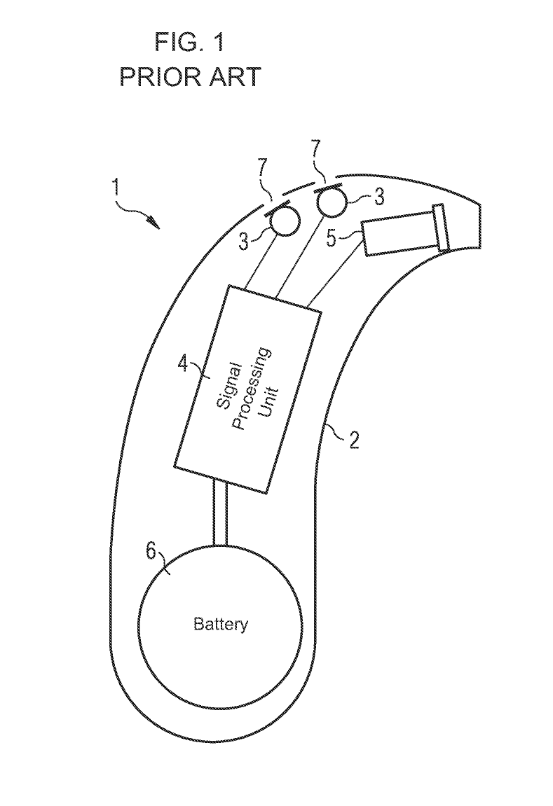

### DETAILED DESCRIPTION OF THE INVENTION

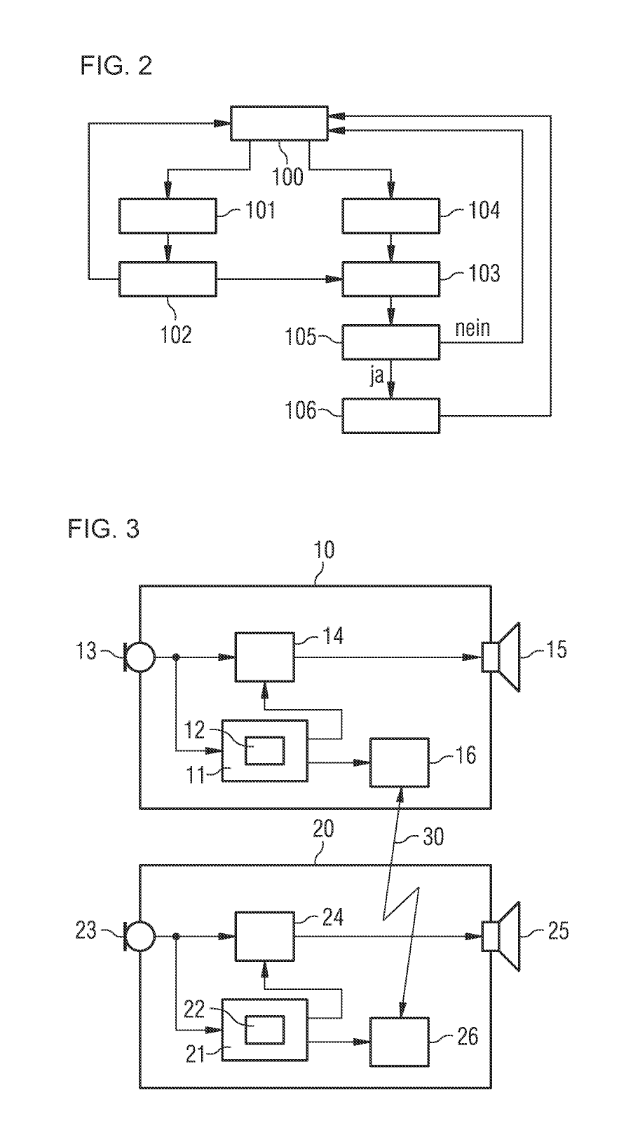

Referring now to the figures of the drawing in detail and first, particularly, to FIGS. 2 and 3 thereof, there is shown a flow diagram of a method for the voice control of a hearing device 10, 20 with voice commands. According to the invention, a first and a second hearing device 10, 20 are used in a binaural configuration to this end. The first hearing device 10 supplies the left ear and the second hearing device 20 the right ear of a hearing device wearer. A first voice recognition method is implemented in the first hearing device 10 and a second voice recognition method in the second hearing device 20. The voice recognition methods can be the same. They have conventional or hearing device-specific voice recognition algorithms. The number of voice commands to be recognized is limited, and as a rule contains five to a maximum of twenty commands.

In the first step 100 the hearing devices 10, 20 wait for the output of a voice command by the hearing device wearer. To this end, the acoustic input signals are analyzed on an ongoing basis. In the following step 101 the first hearing device 10 recognizes a first voice command and transmits this in the subsequent step 102 to the second hearing device with the aid of wireless communication. In step 103 the second hearing device 20 receives the first voice command. The second hearing device 20 has recognized a second voice command in step 104 simultaneously with step 101.

In step 105 the second hearing device 20 compares the self-identified second voice command with the first voice command received from the first hearing device 10. If the two voice commands correspond, the first or as the case may be second voice command is performed in step 106. The method then branches back to step 100. If the two voice commands do not correspond, the method immediately continues with method step 100.

The method can of course also simultaneously proceed in the opposite direction, that is the second hearing device 20 transfers its recognized second voice command to the first hearing device 10. The first hearing device performs the voice command if the self-identified first voice command corresponds with the received second voice command.

Instead of the result of the voice recognition in the form of first or second voice commands, other information data of the first or second voice recognition method can also additionally or alternatively be transmitted to the other hearing device. This “raw data” is then also taken into account in the other first/second voice recognition method during voice recognition.

FIG. 3 shows a circuit diagram of an inventive binaural configuration with a first hearing device 10 and a second hearing device 20, which can exchange data via radio communication 30. The first hearing device 10 contains a first signal processing unit 14, which edits and amplifies acoustic signals recorded by a first microphone 13 in the form of electrical signals and forwards them to a first earpiece 15 for acoustic output. With the aid of a first voice recognition module 11, the microphone signal of the first microphone 13 is analyzed for the presence of previously-known voice commands. Voice recognition takes place with the aid of a first voice recognition algorithm 12 in the first voice recognition module 11. With a first radio module 16 the first hearing device 10 can exchange data wirelessly with the second hearing device 20.

The second hearing device 20 contains a second signal processing unit 24, which edits and amplifies acoustic signals recorded by a second microphone 23 in the form of electrical signals and forwards them to a second earpiece 25 for acoustic output. With the aid of a second voice recognition module 21, the microphone signal of the second microphone 23 is analyzed for the presence of previously-known voice commands. The voice recognition takes place with the aid of a second voice recognition algorithm 22 in the second voice recognition module 21. With a second radio module 26, the second hearing device 20 can exchange data with the first hearing device 10 wirelessly.

If a first voice command is recognized by the first voice recognition module 11, with the aid of the first radio module the first hearing device 10 transmits the recognized first voice command to the second hearing device 20, which receives this first voice command with the aid of the second radio module 26. The second voice recognition module 21 has in turn itself recognized a second voice command. The second voice recognition module 21 now compares the first and the second voice command and controls the second signal processing unit 24 with the second voice command only if the first and the second voice command correspond.

The binaural configuration functions analogously in the reverse direction. The first voice recognition module 11 compares the first and the second voice command and controls the first signal processing unit 14 with the first voice command only if the first and the second voice command correspond.

Instead of or in addition to recognized first and second voice commands, other information data, such as for example acoustic parameters, the results of a Voice Activity Detection or levels of probability of recognized voice commands can also be exchanged with the radio communication 30.

1. A method for voice control of hearing devices using voice commands, the hearing devices including a first hearing device and a second hearing device in binaural configuration, which comprises the steps of:
transferring information data from a second voice recognition method of the second hearing device method to a first voice recognition method of a first hearing device; and
using, in a first voice recognition method of the first hearing device, the information data from the second voice recognition method of the second hearing device for recognition of the voice commands.

2. The method according to claim 1, wherein the information data contains a second voice command recognized by the second voice recognition method.

3. The method according to claim 2, wherein a voice command is only used for voice control if the second voice command corresponds with a first voice command recognized by the first voice recognition method.

4. The method according to claim 1, wherein the information data contains at least one of acoustic parameters, results of a Voice Activity Detection or levels of probability of recognized voice commands.

5. The method according to claim 1, wherein the second voice recognition method is a same as the first voice recognition method.

6. The method according to claim 1, which further comprises transmitting the information data wirelessly from the first hearing device to the second hearing device.

7. A binaural configuration for performing voice control of hearing devices by means of voice commands, the binaural configuration comprising:
a first hearing device having a first voice recognition module; and
a second hearing device having a second voice recognition module, said second voice recognition module using information data from said first voice recognition module for recognition of the voice commands.

8. The configuration according to claim 7, wherein the information data contains a first voice command recognized by said first voice recognition module.

9. The configuration according to claim 8, wherein a voice command is only used for voice control if the first voice command corresponds with a second voice command recognized by said second voice recognition module.

10. The configuration according to claim 7, wherein the information data contains at least one of acoustic parameters, results of a Voice Activity Detection or levels of probability of recognized voice commands.

11. The configuration according to claim 7, wherein:
said first voice recognition module has a first voice recognition algorithm; and
said second voice recognition module has a second voice recognition algorithm.

12. The configuration according to claim 11, wherein the first voice recognition algorithm is a same as the second voice recognition algorithm.

13. The configuration according to claim 7, wherein:
said first hearing device has a first radio module; and
said second hearing device has a second radio module, said first radio module transfers the information data to said second radio module.
